(19) United States
(12) Patent Application Publication
(10) Pub. No.: US 2017/0081560 A1
(43) Pub. Date: Mar. 23, 2017

(54) FLEXIBLE SHEET WITH HARD PARTICULATE

(71) Applicant: Ronald SW Knighton, Fullerton, CA (US)

(72) Inventor: Ronald SW Knighton, Fullerton, CA (US)

(21) Appl. No.: 14/861,876

(22) Filed: Sep. 22, 2015

(51) Int. Cl. C09J 7/04; E04F 15/16; E04F 13/00; E04D 5/08; E04D 5/14

(52) U.S. Cl. CPC C09J 7/04; E04D 5/08; E04D 5/148; E04F 13/002; E04F 15/16

(57) ABSTRACT

A flexible construction material can include a fiber layer, an adhesive layer, and a layer of harder bonded particulates. The fiber layer can be made from any type of fabric including multi-layered, woven or nonwoven fabrics. The adhesive can be applied in a manner that it becomes impregnated into the fiber layer. Additionally, the adhesive can be applied such that it becomes impregnated into a portion of the fiber layer but does not extend completely through the fiber layer. Hard particulate matter can be bonded to the upper surface of the adhesive.

### FIELD OF THE INVENTIONS

The present inventions are related to construction materials and techniques for manufacturing including construction materials such as flexible sheets and layered sheets formed into predetermined shapes, optionally with hard particulate matter attached thereto.

### BACKGROUND OF THE INVENTIONS

The present market for roofing materials is dominated by rigid tiles such as terra cotta or other cement-based rigid roofing materials, asphalt shingles, and metal, all of which require significant effort for fitment and attachment on site. For larger commercial applications, such as roofs of large buildings, a roofing adhesive can be applied in liquid form and, in some applications, hard particulate matter sprinkled upon the adhesive. This technique also requires significant on site labor and appropriate weather conditions.

### SUMMARY OF THE INVENTIONS

An aspect of at least one of the inventions disclosed herein includes the realization that construction materials, such as for roofing, wall coverings, flooring and other applications, can be made from materials by incorporating an appropriate adhesive with a lightweight fabric. Some known prior art designs for roofing material include nonwoven fabrics or asphalt impregnated woven fabrics.

In accordance with at least one of the embodiments disclosed herein, a roofing material comprises a single layer of woven fabric, an adhesive layer comingled with one surface of the layer of fabric but not penetrating to the opposite surface, and hard particulate matter bonded with the second surface of the adhesive.

By combining the appropriate adhesive with the appropriate layer of fabric, an advantageously thin and lightweight product can be manufactured which provides or accommodates a high degree of flexibility, and in some cases, allowing it to be rolled or packaged, for example, for storage and transportation. Such a product can be manufactured in a factory, then transported to a site for installation. As such, it is not necessary to spread loose particulate matter at the installation site.

Another aspect of at least one of the inventions disclosed herein includes the realization that a construction material, which can be waterproof and/or fireproof, can be manufactured at high speed and with equipment accommodating large format sizes, e.g., four-foot wide, eight-foot wide, ten-foot wide or more, continuous sheets by using a combination of an adhesive and a fabric that can easily be attached to each other. For example, the adhesive can be at least partially impregnated into the fabric, but where the adhesive and fabric interact in a way such that the adhesive does not soak through to the backside of the fabric.

For example, an adhesive in a liquid phase can be applied onto a thin fabric in an appropriate manner such that the adhesive becomes impregnated into the fabric but does not soak through to the bottom side. Using such a technique, the fabric can be driven with commonly and commercially available rolling equipment which only touches the backside of the fabric, during at least part of the adhesive application process. For example, the chosen adhesive can be sprayed on with a sufficiently light coat that it does not soak through the fabric. Further, the adhesive used and the fabric used can generate a sufficient surface tension so as to slow the flow of the liquid adhesive into the fabric, thereby preventing the adhesive from soaking all the way through the fabric to the opposite side.

This can provide a further advantage when attaching the material to a structure. For example, the above-described material can be attached to a fixed structure, such as a wall or a roof, with an adhesive. Because the adhesive in the material is not exposed on the backside of the material, the additional adhesive can also become partially impregnated into the fabric, thereby providing a strong bond with the fixed structure.

Another aspect of at least one of the inventions disclosed herein includes the realization that some adhesives can be sprayed on the fabrics using commercially available conveyor systems, and then dry particulate matter can be dropped onto the upper surface of the liquid adhesive, prior to curing, to provide a rollable construction material. For example, using such a technique with an adhesive that can quickly generate a bond with particulate material, such as crumbled rock or sand, the resulting material can then be further drawn through typical manufacturing equipment with rollers in contact with both sides. For example, such additional manufacturing equipment can be heat-curing, coolers, cutters, etc.

Another aspect of at least one of the inventions disclosed herein includes the realization that a lightweight, waterproof and fireproof construction material can be provided with a high degree of flexibility by using a single layer of a woven fabric as opposed to multiple layers of woven fabric or nonwoven fabric. For example, multiple layers of woven fabric, while they can be manufactured with very small thicknesses, once impregnated with adhesive and thereby attached to each other, resist sheer movement relative to one another, and thus resist bending more than a single layer. Additionally, nonwoven fabrics, while widely used in many similar applications, are generally nonuniform at small thicknesses, thereby making it more difficult to partially impregnate such a fabric with an adhesive such that the adhesive does not soak through.

Another aspect of at least one of the inventions disclosed herein includes the realization that flexible adhesive impregnated fabric can be formed into predetermined shapes, for example, geometrically more complicated than rolled or sheet materials, and can be stone-coated so as to be easily installed as desired in a more efficient manner. For example, a single layer of woven fabric can be obtained in tube form. The tube-formed fabric can be placed over a pipe form so as to be held in a pipe shape of a predetermined dimension, then impregnated with adhesive and then stone-coated. After curing, the resulting member remains tube-shaped, stone-coated on an exterior surface, and slidable over a pipe having about the same dimension as the pipe form used during the manufacturing steps. As such, the stone-coated tube member can be easily installed over a roof-penetrating pipe, such as an exhaust or venting pipe commonly used in construction.

### BRIEF DESCRIPTION OF THE DRAWINGS

FIG. 1 is a schematic diagram of an embodiment of construction material comprising hard particulate matter bonded to a fabric, which, in some embodiments, can be rolled.

FIG. 2 is an enlarged schematic diagram of the material illustrated in FIG. 1 showing three layers.

FIG. 2A is an enlarged schematic diagram of another embodiment of the sheet material including a fourth layer.

FIG. 3 is an enlarged perspective view of the material illustrated in FIG. 2 having a first lower layer formed of a single layer of woven fabric, an intermediate layer of an adhesive impregnated into a portion of the first layer, and an upper layer of particulate material bonded to the upper surface of the adhesive layer.

FIG. 3A is an enlarged perspective view of a further embodiment of the material illustrated in FIG. 3.

FIG. 4 is a schematic diagram of a manufacturing system that can be used to manufacture the material illustrated in FIGS. 1-3.

FIG. 5 is an exploded perspective view of components used in an embodiment of a process of manufacturing a particulate-coated tube member.

FIG. 6 is a further perspective view of the components of FIG. 5, in which a nonabsorbent material is placed over a pipe form.

FIG. 7 is a partial sectional of the components of FIG. 5 in which a fabric tube is placed over a nonabsorbent material placed over a pipe form.

FIG. 8 is an enlarged partial sectional view of components of FIG. 5 subjected to a coating process.

FIG. 9 is an exploded view illustrating a process of placing a particulate-coated tube member over a pipe.

FIG. 10 is a partial sectional and schematic view of a process of installing a particulate-coated tube member over a pipe including wrapping an upper end over the top edge of the pipe and enlarging a lower end over a flange.

### DETAILED DESCRIPTION

Embodiments of a construction material with hard particulate matter attached thereto are described below in the context of construction materials that can be used for roofing, siding, wall covers, pipe flanges, vent covering, etc., which can be waterproof and/or fireproof, because these embodiments have particular utility in this context. However, the inventions disclosed herein can be used in other contexts as well.

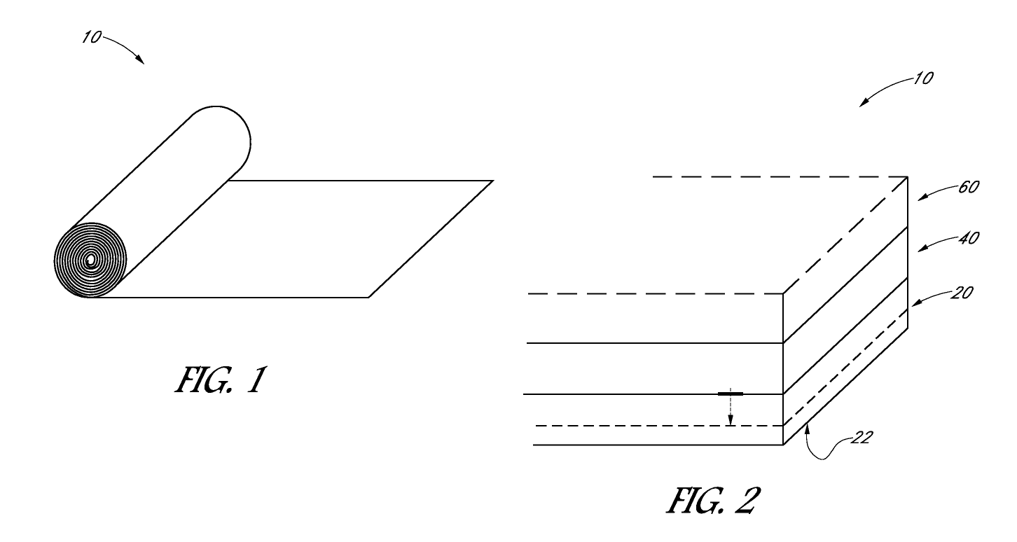

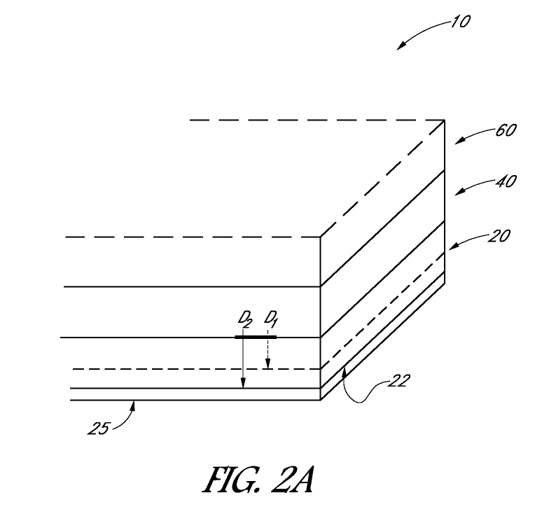

With reference to FIGS. 1 and 2, a construction material 10 can be configured to be sufficiently flexible so it can be rolled, as illustrated in FIG. 1. However, optionally, the material 10 can be configured to have slightly less flexibility and thus more easily manufactured in unrolled, sheet form.

With reference to FIG. 2, the material 10 can comprise three or more layers. In the illustrated embodiment, the material 10 includes a fiber layer 20, an adhesive layer 40, and an outer layer 60.

The fiber layer 20 can be made from any type of fabric including woven, nonwoven fibers in any configuration. In some embodiments, the fiber layer 20 is in the form of woven fabrics having one or more layers. The fiber layer 20 can be muslin 100% cotton fabric having a thread count of about 65 to 200 per square inch. In some embodiments, the fiber layer 20 can have a weight of 3.0 to 7.5 ounces. With regard to the adhesive used for the adhesive layer 40, the fabric layer 20 can be considered an absorbent material. In this context, the term “absorbent” can be considered as meaning allowing a flowable material to flow into an interior of a layer, for example, so as to become impregnated within the layer.

The adhesive layer 40 can be made from any type of adhesive including, but not limited to, hydrophobic adhesives. For example, the adhesive can be RAC™ Self Curing Formula Series No. 763-768 and 770 available from Triangle Coatings, Inc., 4763 Bennett Drive, Livermore, California 94551.

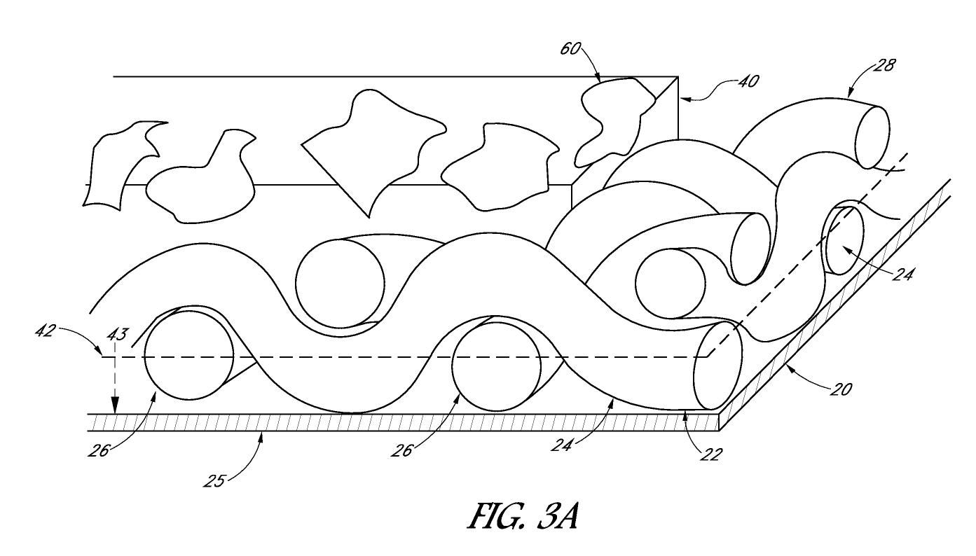

In some embodiments, the adhesive, when applied, has a viscosity such that it can become impregnated into at least a portion of the fiber layer 20. For example, as illustrated in the phantom line, when applied, the adhesive 40 can flow partially into the fiber layer 20. Thus, as noted above, the layer 20 can be considered as being absorbent of the adhesive 40. In some embodiments, the adhesive 40 is applied in a manner such that it does not saturate all of the fiber layer 20 such that it becomes exposed on the bottom surface 22 of the fiber layer. This can have the advantage of allowing the material 10 to be manufactured on a system using rollers (FIG. 4) on a continuous manufacturing line. Additionally, where the adhesive does not flow to the bottom surface, the resulting material can achieve more secure bonding to another structure because additional adhesive used can also flow into the unsaturated portion of the fiber layer.

The outer layer 60 can be comprised of any type of material. In some embodiments, the layer 60 is formed of hard particulate matter such as sand, rock, granite, marble, metals, or other hard, rigid or semi-rigid materials. The layer 60 can be attached to the adhesive layer 40. For example, the adhesive 40 can be chosen so as to provide the desired strength of bonding with the layer 60.

FIG. 2A illustrates an optional embodiment of the material 10, including an additional less-absorbent material layer 25. For example, the less-absorbent material layer 25 can be formed from material that is less absorbent than the fabric layer 20. For example, a layer 25 can be made from any plastic sheet material. In other embodiments, the layer 25 can be applied as a liquid which can be absorbed into the fabric layer 20 and prevents further absorption of the adhesive 40, such as, for example, petroleum jelly, siliconized or oil based coatings. Other materials can also be used.

In some embodiments, the less-absorbent material layer 25 can be pre-attached to the fabric layer 20 (before application of the adhesive layer 40) using an adhesive, such as a small amount of adhesive, for example, in some embodiments, an amount of adhesive that is only sufficient to hold the less-absorbent material layer 25 to the fabric layer 20 temporarily during manufacturing steps. As such, in some embodiments, the adhesive layer 40 can be applied to the fabric layer 20 so that it reaches a depth D2 and comes into contact with the less-absorbent material layer 25, and thus bonds the less-absorbent material layer 25 to the fabric layer 20. In some embodiments, the less-absorbent material layer 25 can be substantially as elastic or flexible as the adhesive layer 40. Further, in some embodiments, the less-absorbent material layer 25 can have substantially the same elasticity and/or flexibility as the fabric layer 20 after having been impregnated and cured with the adhesive layer 40. As such, the less-absorbent material layer 25 can have a limited effect on the mechanical characteristics of the material 10.

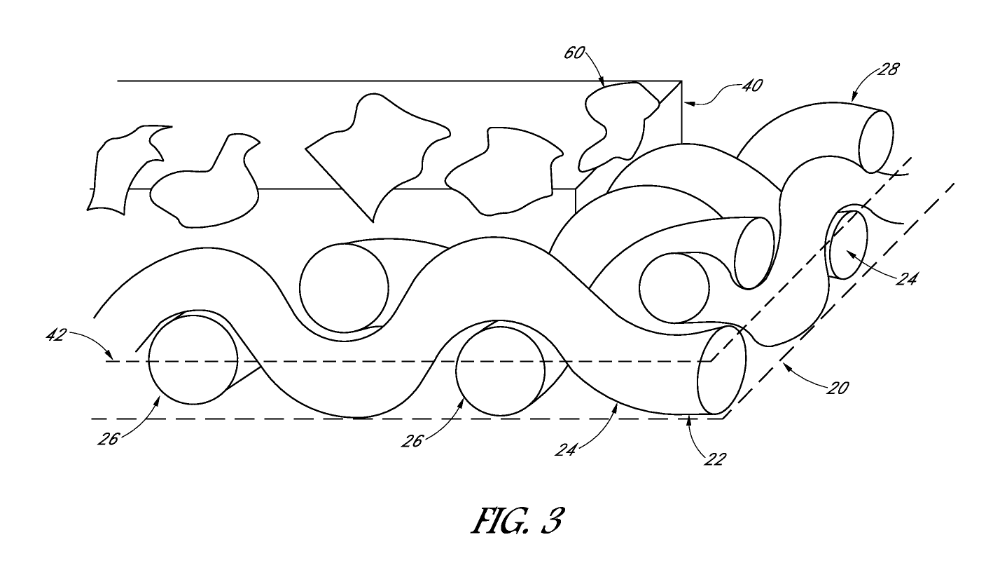

With reference to FIG. 3, a further embodiment of the material 10 is illustrated therein, in a partial perspective and cutaway view. The fiber layer 20 illustrated in FIG. 3 is a single layer of a woven fabric, having longitudinal threads 24 and transverse threads 26. The illustrated woven configuration of the fiber layer 20 is merely exemplary and other weave patterns can also be used. The threads 24, 26 of the fiber layer 20 can be any type of thread. For example, the threads 24, 26 can be in the form of bundled fibers of material such as, but not limited to, cotton, polyester, hemp, or other natural or artificial fibers.

The adhesive layer 40, as noted above, can be formed from any type of adhesive. In some embodiments, the adhesive 40 can be applied as a liquid sprayed onto an upper surface 28 of the fiber layer 20. Thus, the surface tension generated between the threads 24, 26 and the adhesive 40 can affect the wetability of the fiber layer 20 with the adhesive 40. In some embodiments, the upper particulate layer 60 can be glazed with a glaze commercially available as Glaze Stone Shield No. 571 and RAC No. 769, available from Triangle Coatings, Inc., 4763 Bennett Drive, Livermore, California 94551.

In some embodiments, the adhesive 40, when in a liquid state, can have a viscosity of between 50 and 150 KU and in some embodiments, between 100 and 120 KU. In some methods of manufacturing, a roll of the fiber layer 20, such muslin fabric, between 36 and 72 inches wide can be used.

As noted above, in some embodiments, the adhesive 40 can be applied in a way so as to flow into and become impregnated into at least a portion of the fiber layer 20. The phantom line 42 illustrates a lower level of adhesive 40 as it has flowed into the fiber layer 20. As shown, the adhesive 40 becomes impregnated into an upper portion of the fiber layer 20, but stops and does not extend to the lower surface 22 of the fiber layer 20.

The upper layer 60, as noted above, can be any type of material including, for example, but without limitation, sand, granules, hard particulate materials, granites, marbles, or other materials. In some embodiments, the layer 60 is formed of small particulates of material, between 1 and 5 millimeters. However, smaller or larger particulates can also be used.

In some embodiments, the fiber layer 20 and the adhesive 40 chosen can provide desired strength and flexibility. For example, in some embodiments, the material 10 can be configured to provide an elongation of 5%-30% for material thicknesses of 6-30 mils. Greater resistance and tensile strengths can be achieved by using a greater thickness of wet film thickness (WFT).

In some embodiments, the above noted glaze can provide additional fire resistance to the material 10. For example, the material 10 can achieve a Class A fire rating in accordance with standard ASTM E-108, where the material 10 is used for roofing. Further, the material 10, in some embodiments, can satisfy the Accelerated Weather ASTM G26, Wind Uplift Resistance standard UL-580, Salt Spray standard ASTM-B-117, the ICBO Wind Driven Rain standard AC-07, and/or Class 4 Hail Impact Resistance UL-2218.

With reference to FIG. 3A, as noted above with reference to FIG. 2A, the material 10 can also include a less-absorbent material layer 25. As illustrated in FIG. 3A, the less-absorbent material layer 25 can come into contact or be bonded to the fabric layer 20. For example, the phantom arrow 43 illustrates a further depth to which the lower level of adhesive 40 can flow into and through the fabric layer 20, into contact with the less-absorbent material layer 25. Further, the less-absorbent material layer 25 can be bonded to the fabric layer 20, with the adhesive layer 40.

With reference to FIG. 4, the material 10 can be manufactured in a continuous manufacturing line technique. The illustrated schematic of a manufacturing system shown in FIG. 4 is an exemplary system that can be used. Other systems can also be used.

As shown in FIG. 4, a roll of the fiber layer 20 is supported on a supply roller stand 102. Coil tensioners 104 can be arranged in proximity to the supply roll 102 as is well known in the art. The construction control and operation of the feed system of the fiber layer 20 as part of the system 100 is constructed from commercially available and well known components. Thus, a detailed description of those components is not included below. Additionally, most of the rollers are illustrated without supports and one of ordinary skill in the art will understand that such rollers described below are supported in the conventional manner.

The system 100 can also include an adhesive application device 110. The adhesive application device 110 can be in the form of any type of device configured to apply an adhesive to a continuously moving roll of material, such as the fiber layer 20. In some embodiments, the device 110 is in the form of a reciprocating spray booth.

For example, the reciprocating spray booth 112 can include an outer housing forming a hood over an area where the fiber layer 20 passes through. Additionally, the reciprocating spray booth 112 can include a spray head connected to a supply of adhesive 40 (not shown) and which either is fixed and sprays adhesive onto the fiber layer 20 as it moves through the booth 112 or reciprocates laterally to apply the adhesive 40. Other devices can also be used.

As noted above, in some embodiments, the adhesive is sprayed on to an upper surface of the fiber layer 20 at a rate such that the adhesive 40 becomes impregnated into a portion of the fiber layer 20 but does not flow down to the bottom surface of the fiber layer 20. Thus, the amount of adhesive sprayed onto the fiber layer 20 can be adjusted to prevent the adhesive 40 from flowing to the bottom surface of the fiber layer 20. Additionally, the viscosity of the adhesive 40, the ambient temperature, the humidity, and other factors can all be adjusted so as to achieve the desired level of impregnation of the adhesive 40 into the fiber layer 20, without flowing down to and being exposed on the bottom surface 22 of the fiber layer 20.

In some embodiments, the adhesive application device 112 can be configured to apply an amount of adhesive sufficient to form a Wet Mil Thickness (WMT) of 8 to 24 mils. However, other thicknesses can also be used.

The system 100 can also include an outer layer application device 120. In some embodiments, the outer layer application device 120 can be configured to deliver hard particulate material onto the upper surface 28 of the fiber layer, upon which adhesive has been applied.

In some embodiments, the upper layer application device 120 can be in the form of a stone curtain hopper with sifters and a reclaim system. For example, the device 120 can include an upper delivery portion 122 configured to drop a curtain of particulate matter onto the upper surface 28 as the roll of fiber layer 20 passes beneath the upper 122. The amount of material dropped from the device 122 can be in excess of what is needed to coat the upper surface 28. As such, the material that touches the exposed liquid adhesive is bonded to the adhesive.

The device 122 can also include a reclaim hopper 124 configured to catch excess particulate matter from the upper surface 28 of the fiber layer 20. For example, the reclaim device 124 can include a hopper 126 disposed above a reversing roller arrangement 128, which reverses the direction of the fiber material 20 thereby inverting the upper surface 28 of the fiber layer 20 over the hopper 126. Thus, as the fiber layer 20 moves around the reversing roller 128, any excess material applied by the device 122 falls into the hopper 126. The device 120 can include augers, pneumatic conveyor, and/or other devices to return particulate matter collected in the hopper 126 to the delivery device 122.

Optionally, the system 100 can also include a glaze application device 130. The glaze application device 130 can be in the form of a reciprocating spray booth. However, other devices can also be used. The reciprocating glaze spray booth can include a housing, and fixed or reciprocating spray heads configured to spray a glaze onto the particulate matter adhered to the upper surface 28 of the fiber layer 20.

The system 100 can also include a curing device 140 configured to apply heat to the material as it passes air through and/or provide other curing environments. As shown in the schematic of FIG. 4, the curing device 140 has a plurality of rollers, some of which touch the upper surface of the material and some of which contact the lower surface 22. As noted above, by applying the adhesive 40 in a manner such that the adhesive does not flow and become exposed onto the bottom surface 22 of the fiber layer 20, the material can come into contact with rollers both at its upper surface (after application of the layer 60) and its lower surface, without sticking Thus, the material can be wound in multiple passes through devices such as the curing oven 140 without sticking.

The system 100 can also include an optional cooling chamber 150 configured to cool down the material as it passes from the curing device 140. A further arrangement of tensioning devices 160 and a collection roller 170 can be connected at the end of the system 100 to roll the material 10.

Optionally, in other embodiments, the material 10 discharged from the cooling chamber can lay flat and cut into flat sheets without being rolled. Optionally, although not illustrated, the material can be manufactured in separate sheets without rolling. For example, fiber layer 20 can be stretched across a frame, similar to a picture frame or any other type of frame designed to hold fabrics in tension, as are widely used and well known in the arts.

With the fiber layer 20 held in a frame, the adhesive 40 can be applied manually. For example, the adhesive can be applied to provide a wet mil thickness between 1 and 30 mils. In some embodiments, the thickness of the adhesive 40 is between 8 and 24 mils. The magnitude of the wet mil thickness used can be determined so as to provide the desired effect and bonding with the size of the particulate materials that may be applied to the upper surface of the adhesive. Using this technique, the particulate materials, such as sand, granules, granites, marble, stone, metals, can be dropped onto the upper surface of the adhesive. After the adhesive has dried for a sufficient amount of time, the excess particulate matter can be removed simply by inverting the frame and allowing gravity to pull the excess particulate matter off of the frame.

Similar to the process above, optional glazes can be applied to the upper surface of the particulate material.

In this process, the material can be simply-air cured. For example, the glaze coated fabric frame can be placed on stationary or mobile racks for curing at ambient temperature. In some embodiments, curing can require as little as one hour and in some cases a couple of hours without the need for heat curing, which can provide significant energy savings and thus reduced manufacturing costs.

After the material is properly cured, the material 10 can be removed from frames and cut into the desired sizes and shapes.

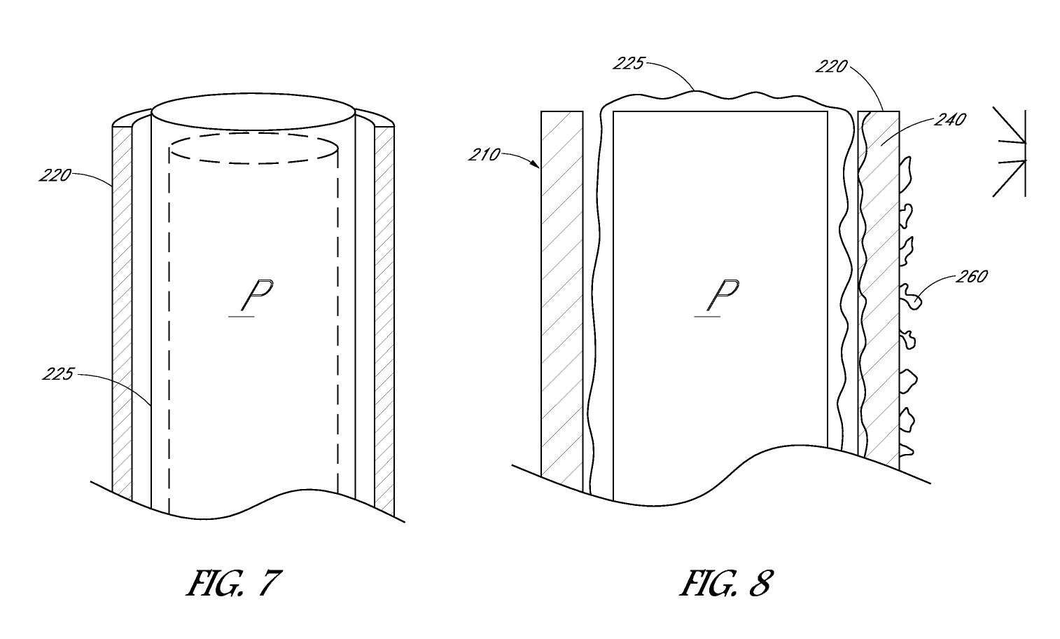

FIGS. 5-8 illustrate an embodiment of the method for manufacturing a material having a predetermined shape, the material identified generally by the reference numeral 210 (FIG. 8). Parts, components, features, and characteristics of the material 210 which are the same or similar to the material 10 are identified with the same reference numeral, except that a 200 has been added thereto.

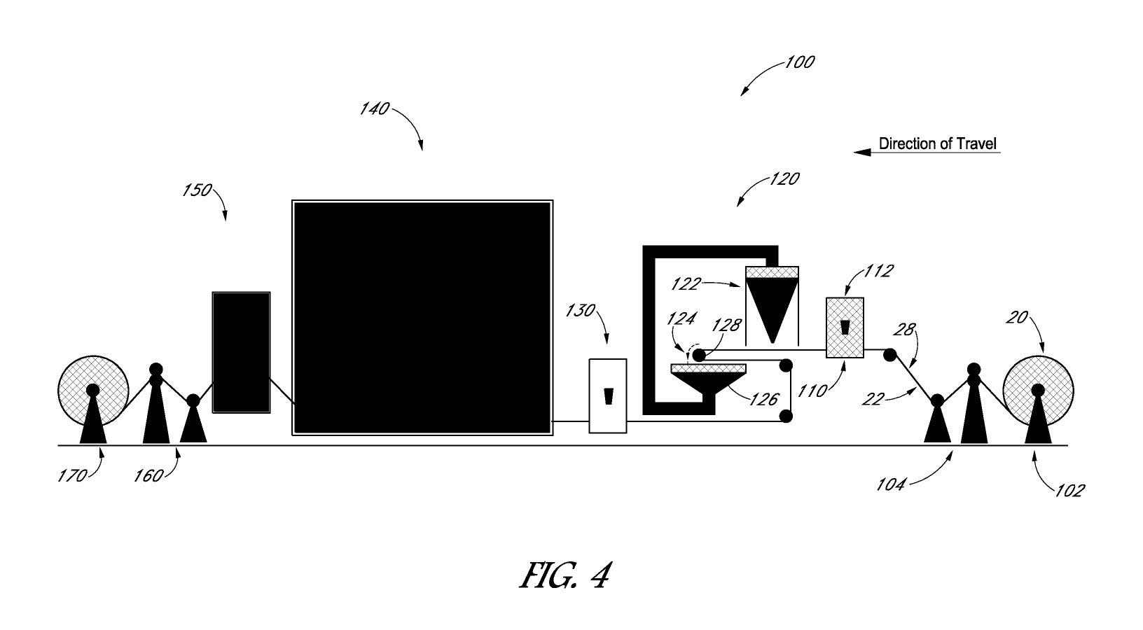

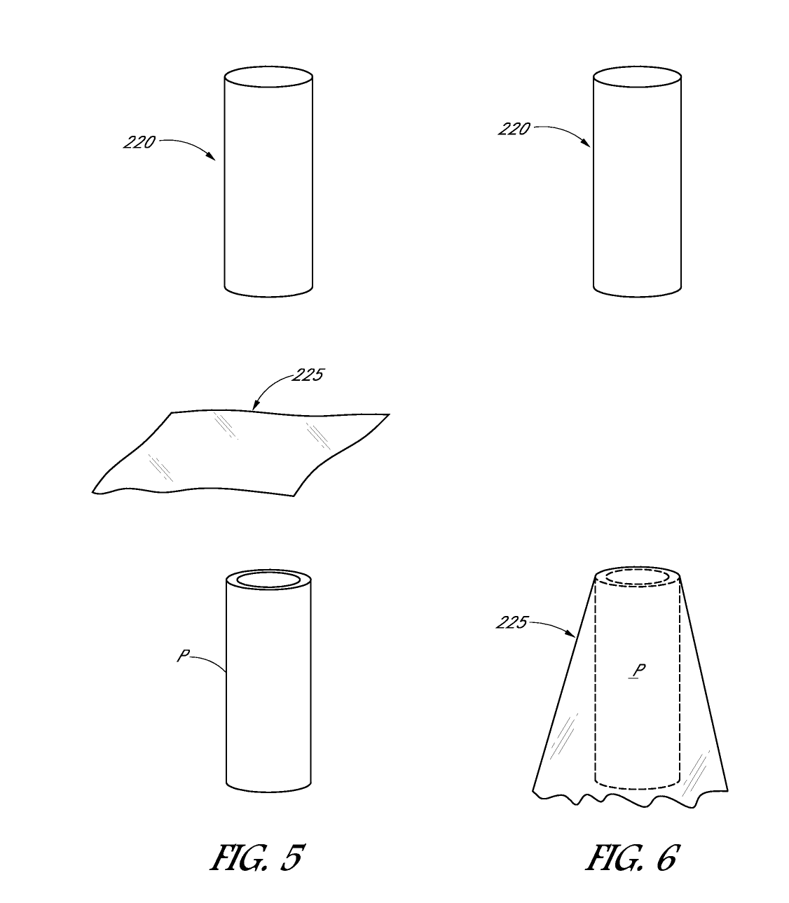

With reference to FIG. 5, the material 210 can be manufactured starting with a fabric layer 220 in a cylindrical form. For example, the material 220 can be in the form of tubular knitted fabric, commercially available as rib tube fabric, in multiple sizes, diameters, thread counts, and denier values. The method of manufacturing the material 210 can include using the material 220 in conjunction with a pipe form P having a diameter equal to or substantially the same as a pipe used on the roof of a structure. The diameter of the layer 220 can be chosen to be, in a relaxed state, about the same or slightly smaller than the pipe form P. Additionally, in some embodiments, the less-absorbent layer 225 can be placed over the pipe form P, as shown in FIG. 6. With the less-absorbent material placed over the pipe form P, the layer 220 can be moved over the less-absorbent material layer 225, as shown in FIG. 7. In this configuration, the layer 220 can be slightly stretched from its relaxed state and with the less-absorbent material layer 225, disposed between the layer 220 and the pipe form P.

As shown in FIG. 8, in this configuration, in which the fabric layer 220 may be stretched slightly from its relaxed state, adhesive 240 can be sprayed onto the layer 220 so as to be absorbed into and impregnate the layer 220. The depth to which the adhesive 240 flows into the material can be limited such that it does not extend in all the way to the inner surface of the layer 220. However, in some embodiments, the adhesive 240 can be applied in a sufficient quantity such that the adhesive 240 reaches the inner surface of the layer 220. As such, any of the adhesive 240 that reaches the less-absorbent material layer 225 may interact with the layer 225 but would not contact or bond with the pipe form P.

In this state, particulate matter 260 can be applied to the outer surface of the fabric layer 220 and become bonded to the fabric layer 220 with the adhesive layer 240.

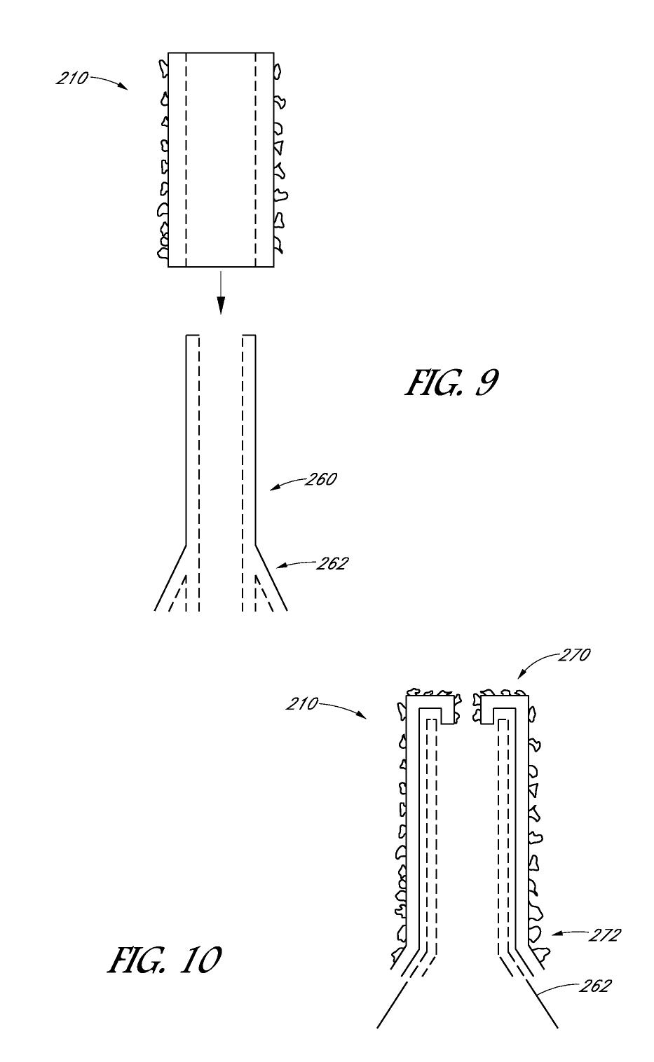

With reference to FIG. 9, after curing, the material 210 can be moved down onto a pipe which may be protruding through the roof of a structure (not shown) and which may have a flange 262 at a lower end.

As shown in FIG. 10, an upper end 270 of the material 210 can be folded over and into the interior of the pipe 260 so as to prevent water from entering a space between the inner surface of the material 210 and the outer surface of the pipe 260. Additionally, a lower end 272 of the material 210 can be elastically enlarged to fit over the flange 262. The upper and lower ends 270, 272 can also be further bonded to the pipe 260 and flange 262 using commercially available roofing adhesive and in some embodiments, the RAC No. 770 adhesive described above. Other attachment techniques can also be used.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features.

What is claimed is:

1. A construction material comprising:
a first layer of woven fabric having a first thickness, a first fabric side and a second fabric side;
a first layer of adhesive having a first adhesive side and a second adhesive side, the first adhesive side being at least partially impregnated into the first layer of woven fabric on the first fabric side;
a layer of hard particulate material bonded to the second adhesive side of the first layer of adhesive.

2. The construction material according to claim 1 wherein the first layer of woven fabric comprises at least 50% cotton.

3. The construction material according to claim 2 wherein the first layer of woven fabric comprises a muslin 100% cotton fabric.

4. The construction material according to claim 1 wherein the first layer of woven fabric comprises a thread count of about 65 to 200 threads per square inch.

5. The construction material according to claim 1 wherein the layer of adhesive comprises a cured adhesive that has a viscosity of about 100-120 KU prior to curing.

6. The construction material according to claim 1 wherein the material does not include any other layers of fabric juxtaposed to the first layer of woven fabric.

7. The construction material according to claim 1 wherein the first layer of adhesive does not include volatile solvents prior to curing.

8. The construction material according to claim 1, wherein the first layer of woven fabric is one of a tube and a flat sheet.

9. The construction material according to claim 1, wherein the first layer of adhesive does not extend to the second fabric side.

10. The construction material according to claim 1, additionally comprising a barrier layer disposed on the second fabric side, the barrier layer being less absorbant than the first fabric layer.

11. A method of manufacturing construction material, the method comprising:
applying a liquid adhesive to a first surface of a portion of woven fabric;
allowing the liquid adhesive to become impregnated into the first surface of the woven fabric;
contacting particulate matter to the liquid adhesive; and
curing the liquid adhesive.

12. The method of manufacturing construction material according to claim 11, wherein the step of applying the liquid adhesive comprises coating the woven fabric with an average thickness of the adhesive of 8 to 24 mills.

13. The method of manufacturing construction material according to claim 11, wherein the step of applying comprises applying the liquid adhesive having a viscosity of about 100-120 KU.

14. The method of manufacturing construction material according to claim 11, wherein the step of applying comprises applying the liquid adhesive to a single layer of woven fabric.

15. The method of manufacturing construction material according to claim 14, wherein the step of applying comprises applying the liquid adhesive to the single layer of woven fabric having a thread count of about 65 to 200 threads per inch.

16. The method of manufacturing construction material according to claim 11, wherein the step of curing comprises allowing the adhesive to cure at ambient conditions for at least one hour without the application of heat.

17. The method of manufacturing construction material according to claim 11, wherein the step of curing comprises applying heat to the liquid adhesive.

18. The method of manufacturing construction material according to claim 11, wherein the step of applying comprises feeding a continuous sheet of the fabric from a first roller assembly to an adhesive application device, applying the liquid adhesive with the adhesive application device thereby forming adhesive coated fabric, and wherein the step of contacting comprises feeding the adhesive coated fabric to a particulate delivery device which contacts particulate matter to an upper surface of the liquid adhesive thereby forming particulate coated fabric having an upper particulate surface, then feeding the particulate coated fabric through an inverting roller such that the upper surface of the liquid adhesive faces downwardly, thereby causing excess particulate matter to fall off of the upper surface of the liquid adhesive.

19. The method of manufacturing construction material according to claim 18, additionally comprising contacting a second roller to the upper particulate surface.

20. The method of manufacturing construction material according to claim 11, additionally comprising preventing the liquid adhesive from flowing through the woven fabric and being exposed on a second surface of the woven fabric which is opposite the first side of the woven fabric.

21. The method of manufacturing construction material according to claim 11, additionally comprising adding an additional layer to the second side of the fabric, the additional layer being less absorbent than the fabric.
